(19) United States
(12) Patent Application Publication
(10) Pub. No.: US 2002/0083811 A1
(43) Pub. Date: Jul. 4, 2002

(54) Deburring apparatus for a workpiece

(76) Inventor: Narabu Inafuku, Ayase-shi (JP)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/834,399

(22) Filed: Apr. 13, 2001

(30) Foreign Application Priority Data
Dec. 28, 2000 (JP) 2000-401025

(51) Int. Cl. B26F 1/14

(52) U.S. Cl. 83/136; 83/454

(57) ABSTRACT

A workpiece is placed between a punch and a lower die. The punch is moved down onto the lower die to punch a burr formed on the outer circumference of the workpiece. The burr that is stuck on the lower end of the punch is then removed from the punch by moving the punch up and contacting it to a stationary member. The annular burr thus removed falls onto a burr receiver and is discharged to the outside.

### BACKGROUND OF THE INVENTION

The present invention relates to a deburring apparatus for a workpiece and especially to a deburring apparatus for removing an outer circumferential burr at a valve head of a poppet valve.

A poppet valve which has a valve head at the end of a valve stem is manufactured by two steps comprising a hot drawing forging step for forming an intermediate which includes the valve head, and a hot forging step for pressing the head to an umbrella-shape. In the hot forging step, an excessive material between upper and lower dies forms an annular burr on the outer circumference of the workpiece.

The burr causes problems in a next step for padding a valve face and has to be removed. It is generally cut off by a lathe, which is complicate to result in low efficiency and yields.

The applicant developed a deburring apparatus for punching an outer circumferential burr of a head automatically and rapidly as disclosed in Japanese Patent Pub. No. 6-234027. By the deburring apparatus, the outer circumference of the workpiece is supported by an upper opening of a shape hole of a lower die, and a punch is lowered to punch the burr to a ring. The punched burr is stuck on the outer circumference of the punch, and is removed from the punch by a stripper.

The deburring apparatus is used only for cold processing, When the burr is punched by cold processing, it is not so strongly stuck on the outer circumference of the punch. So it can be easily removed by spring force of the stripper.

However, deburring of Austenite heat-resistant steel causes a crack in a sheared surface by cold processing, and it is found that deburring of such a workpiece should be carried out by warm or hot processing. In such warm or hot deburring, the burr which is thermally expanded before punching is rapidly cooled after punching to result in thermal shrinkage when the burr is engaged on the punch, to bind the outer circumference of the punch strongly and to become warped upwards. Thus, the punched burr is not easily removed by a known spring stripper.

To solve the problem, it is suggested to increase downward force by increasing elastic force, but requires a large high-pressure deburring apparatus since pressing load is lost owing to reaction force of the spring when the punch is lowered.

The known deburring apparatus has no means for holding the burr, thereby causing irregularity in an external diameter of the head after punching or generating a new burr on the sheared surface.

In the foregoing apparatus, the burr removed from the punch is blown off by compression air and discharged from the die to the outside, but the burr is liable to catch on a guide rod or the shape hole, so that it cannot be easily discharged.

### SUMMARY OF THE INVENTION

In view of the disadvantages, it is an object of the present invention to provide a deburring apparatus of the outer circumference of a workpiece for surely removing a burr which is punched and engaged strongly on a punch, pressing load of the punch being prevented from causing loss, the burr being removed from the punch easily and discharged surely.

To achieve the object, according to the present invention, there is provided a deburring apparatus for a workpiece, comprising:

a lower die which has a hole for supporting a lower surface of a burr formed on an outer circumference of the workpiece;

an elevating plate which is movable up and down opposite to the lower die;

a punch which is fixed to the elevating plate to project downward;

a moving plate which is vertically movable and has a pressing member in which a lower end of the punch is engaged; and

a plurality of pressing rods which are movable up and down with the moving plate and are slidably engaged in the elevating plate, said punch being moved down and engaged in the hole of the lower die to punch the burr of the workpiece, said plurality of pressing rods being engaged on the lower surface of a stationary member when the elevating plate elevates to an upper limit position.

When the punch is moved down and engaged in the hole of the lower die, the burr of the workpiece is punched and stuck to the lower end of the punch. Then, the plurality of pressing members is moved up with the elevating plate and is engaged on the lower surface of the stationary member. The burr that is stuck at the lower end of the punch is easily removed from the punch by the pressing member of the punch.

### BRIEF DESCRIPTION OF THE DRAWINGS

The features and advantages of the invention will become more apparent from the following description with respect to embodiments as shown in the accompanying drawings wherein:

FIG. 1 is a side elevational view which illustrates one embodiment of a deburring apparatus of the present invention;

FIG. 2 is a partially cutaway front view of upper and lower die sets before punching of a burr of a workpiece;

FIG. 3 is a partially cutaway front view during punching;

FIG. 4 is a partially cutaway front view when the upper die set is elevated after punching;

FIG. 5 is a partially cutaway front view when the upper die set comes to the upper limit;

FIG. 6 is an enlarged front view when a discharger is moving forwards;

FIG. 7 is an enlarged vertical sectional view taken along the line VII-VII in FIG. 6; and

FIG. 8 is an enlarged vertical sectional side view of a main part when the burr receiver comes to the rear limit.

### DETAILED DESCRIPTION OF PREFERRED EMBODIMENTS

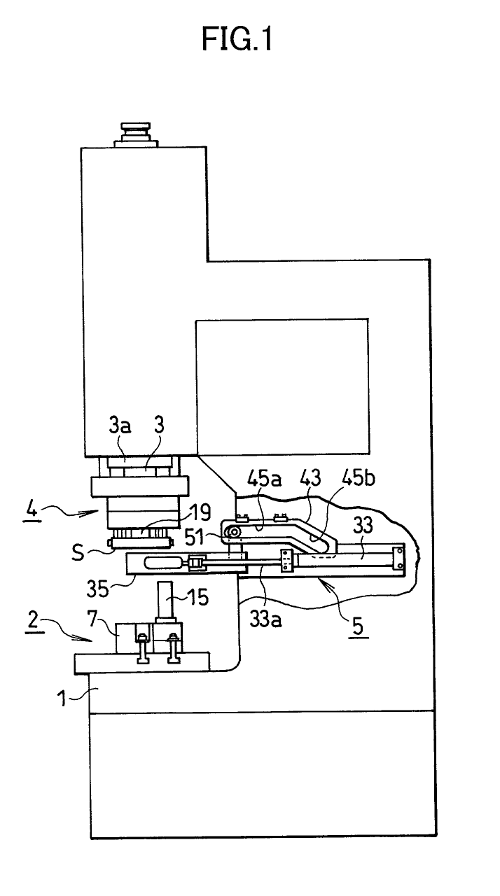

FIG. 1 illustrates a side elevational view of a deburring apparatus according to the present invention, which comprises a base 1, a lower die set fixed to the base 1, an upper die set 4 which is elevated by a ram 3, and a discharger 5 which discharges a removed burr to the outside.

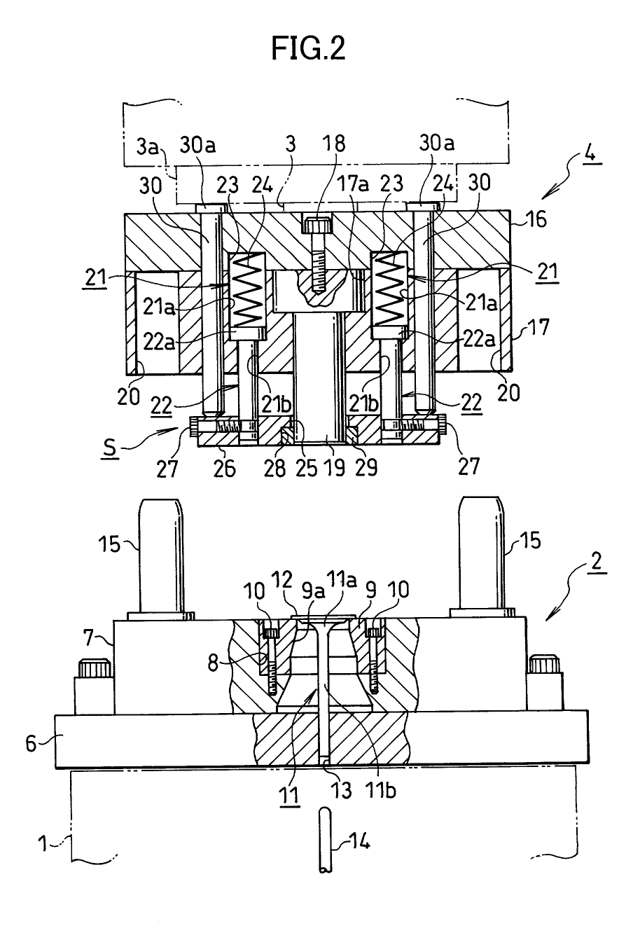

As shown in an enlarged front elevational view of FIG. 2, the lower die set 2 comprises a base plate 6 and a workpiece support 7 screwed thereon. A lower die 9 having a hole 9a is engaged in a bore 8 on the support 7 is engaged with by a plurality of bolts 10 such that the upper surface of the lower die 9 is coplanar with the upper surface of the support 7.

The diameter of the hole 9a is determined so as to support the lower surface of a burr 12 generated on the outer circumference of a head 11a of a workpiece 11, such as a poppet valve that is employed in an internal combustion engine of a vehicle such as an automobile. In the base plate 6, a support bore 13 in which a stem 11b of the workpiece 11 is held is formed to be coaxial with the hole 9a. The numeral 14 denotes a eject pin which is elevatably provided in the base 1 under the support 13 to discharge the workpiece 11.

On the workpiece support 7, there is provided a pair of guide rods 15,15 for guiding the upper die set 4, which comprises an elevating plate 16 connected to the ram 3, a guide plate 17 fixed on the lower surface of the plate 16, and a punch 19 which is detachably engaged in the hole 17a of the guide plate 17 by a bolt 18 through the elevating plate 16 such that a lower half of the punch 19 is projected from the guide plate 17. In the guide plate 17, there is formed a guide bore 20 in which the guide rod 15 of the lower die set 2 is engaged when the upper die set 4 is lowered. On the guide plate 17 at each side of the punch 19, there are formed shouldered bores 21,21 each of which comprises a larger diameter bore 21a and a smaller diameter bore 21b. A suspended rod 22 which has a head 22a is slidably engaged in the shouldered bore 21 not to fall by putting the head 22a in the larger diameter bore 21a.

The suspended rod 22 is always energized downward by a compression spring 24 in the larger diameter bore 21 a and a recess 23 on the lower surface of the elevating plate 16. At the lower end of the suspended rod 22, a moving plate 26 which has a through bore 25 in which the punch 19 is inserted is engaged, and prevented from falling by a bolt 27.

In a larger diameter portion 28 of the through bore 25, a pressing ring 29 is inserted such that its lower surface is coplanar with the lower surface of the moving plate 26 and slightly lower than the lower end of the punch 19. The internal diameter of the pressing ring 29 is determined such that the ring 29 is slidably engaged on the outer circumferential surface of the punch 19.

A pair of pressing rods 30,30 is provided near the suspended rods 22 through the elevating plate 16 and the guide plate 17 to move up and down. There is a gap between the lower end of the rod 30 and the upper surface of the moving plate 26.

A head 30a of the pressing rod 30 is engaged on the lower surface of a stationary ram plate 3a of the apparatus when the upper die set 4 is positioned at the upper limit. Each of the pressing rods 30 presses the moving plate 26 to the lower limit. The suspended rod 22, the compression spring 24, the moving plate 26, the pressing ring 29 and the pressing rod 30 constitute a stripper device “S” for the burr after punching.

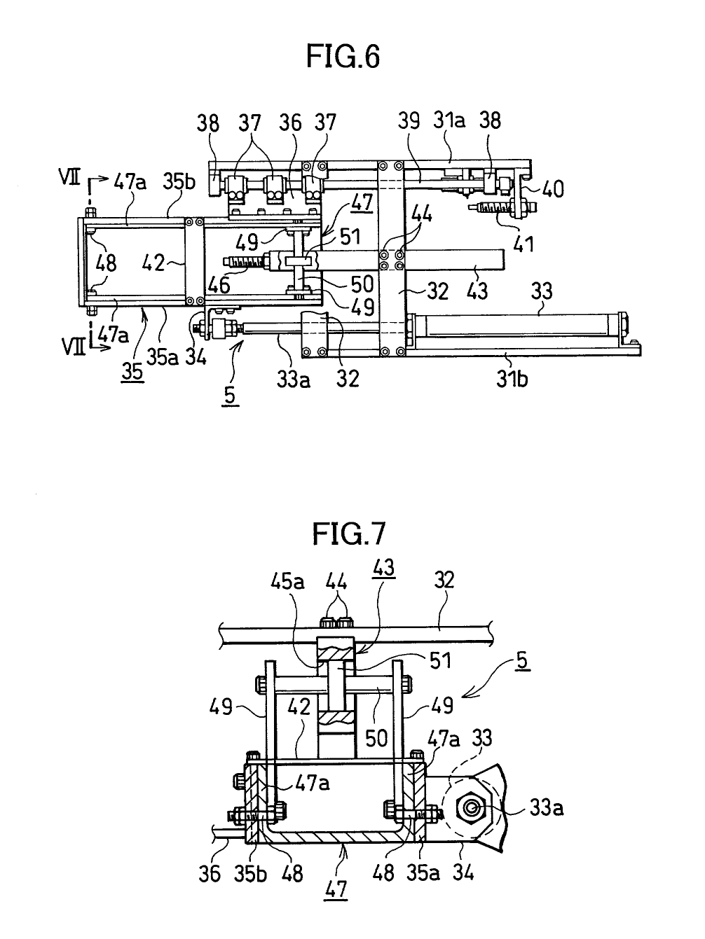

As shown in FIGS. 6 to 8, the discharger 5 is provided between a pair of mounting plates 31a,31b. The mounting plates 31a,31b are connected to each other by two connecting plates 32 at the upper end.

On the inner side surface of the mounting plate 31b, an air cylinder 33 is horizontally fixed and has a piston rod 33a in the front. The front end of the piston rod 33a is mounted to a side plate 35a of a support frame 35 by a an inverted-L-shaped bracket 34.

An L-shaped support plate 36 is screwed to the rear part of a side plate 35b of the support frame 35, and three guide bushes 37 are mounted to the left end of the support plate 36.

The guide bushes 37 are slidably engaged on a guide rod 39 supported between support members 38,38 fixed to the left-side mounting plate 31a. Thus, the support frame 35 is supported by the piston rod 33a and the guide rod 39 to move front-to-back by the air cylinder 33.

At a bracket 40 fixed to the rear end of the mounting plate 31a, a stopper 41 with a shock absorber is mounted. The rear end of the support plate 36 is engaged with the stopper 41 at the rear limit of the support frame 35.

The numeral 42 denotes a connecting plate which connects the upper ends of the middle of the side plates 35a and 35b.

On the lower surface of the connecting plate 32, the upper surface of a guide plate 43 which is bent at a predetermined angle such as 30° downward is fixed by a plurality of bolts 44.

In the guide plate 43, a horizontal guide bore 45a communicates with an inclined guide bore 45b. Numeral 46 denotes a stopper bolt 46 which is engaged in the guide bore 45a to project from the front end face of the guide plate 43,

In the support frame 35, a burr receiver 47 which is almost equal in length to the support frame 35 and opens at the upper surface and is provided to pivot around a bolt 48 which is mounted to side plates 47a and the side plates 35a,35b of the support frame 35.

The lower ends of a pair of suspended plates 49,49 are screwed to the side plates 47a of the burr receiver 47, and the upper ends of a support shaft 50 which is inserted in the guide bore 45a of the guide plate 43 are screwed to the upper end of the suspended plate 49.

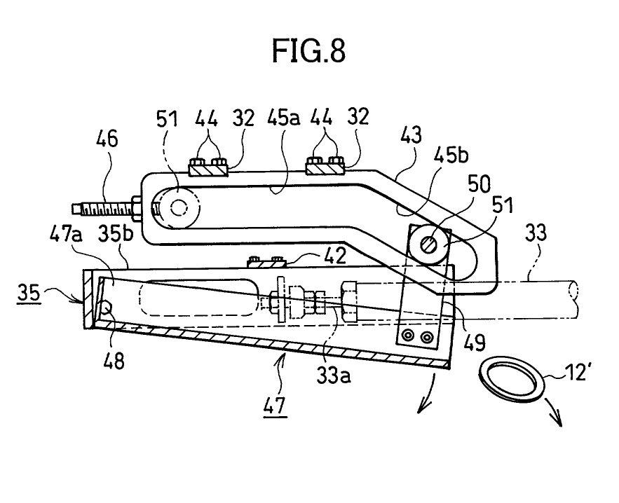

A guide roller 51 is rotatably engaged to the center of a support shaft 50, and is rotated from a front end position as shown by a dotted line in FIG. 8 to a rear end position in the guide bores 45a,45b of the guide plate 43. At the rear end position, the burr receiver 47 is inclined around the front end at a predetermined angle downwards.

Operation of the embodiment will be described.

As shown in FIG. 2, the ram 3 is elevated. When the upper die set 4 is elevated to the upper limit, the workpiece 11 which has high temperature right after hot forging is inserted into the hole 9a of the lower die 9 of the lower die set 2 and the lower surface of the burr 12 generated on the outer circumference of the head 11a is supported.

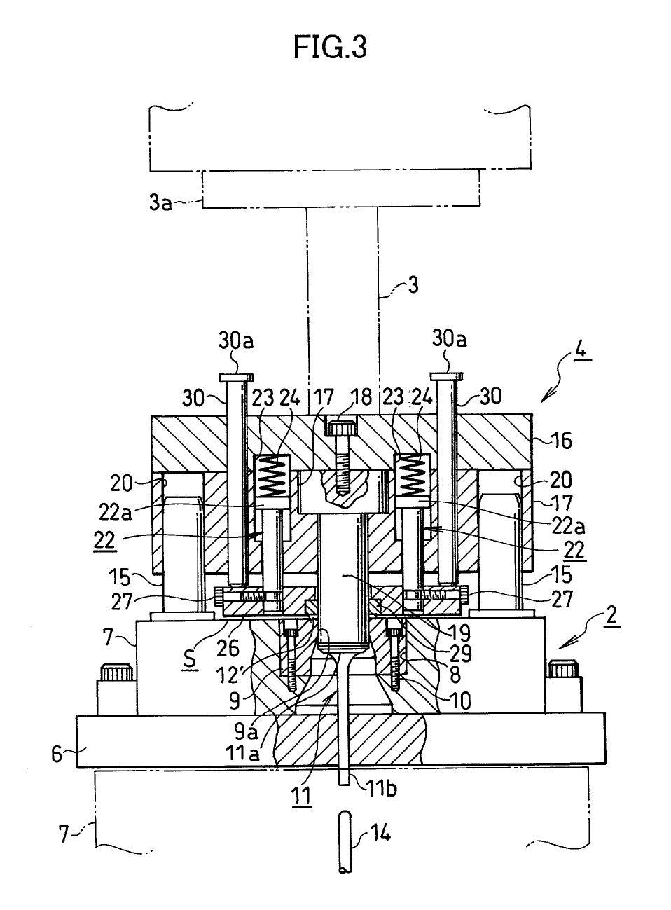

Then, as shown in FIG. 3, the ram 3 is lowered by a predetermined distance to move the upper die set 4 to a position in which the lower surface of the guide plate 17 is very close to the upper surface of the lower die set 2.

During the movement, the lower surface of the pressing ring 29 of the stripper device “S” is engaged on the upper surface of the burr 12. The burr 21 is pressed by force of the compression spring 24. The punch 19 is inserted into the hole 9a to press the workpiece 11 down strongly, so that the burr 12 is removed from the head 11a. An annular burr 12′ thus removed is stuck on the outer circumferential surface of the punch 19.

Then, the upper die set 4 is elevated with the ram 3. The annular burr 12′ is rapidly cooled by the punch 19 and shrunk thermally, so that the burr 12′ is strongly stuck on the outer circumferential surface of the punch 19.

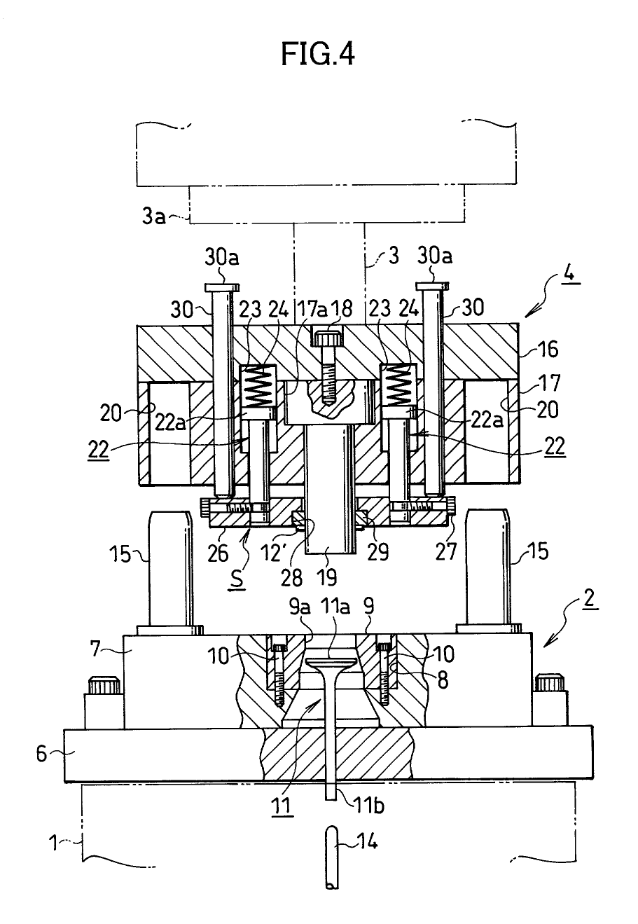

Therefore, as shown in FIG. 4, during elevation of the upper die set 4, it becomes difficult to remove the annular burr 12′ from the punch 19 only by force of the compression spring 24.

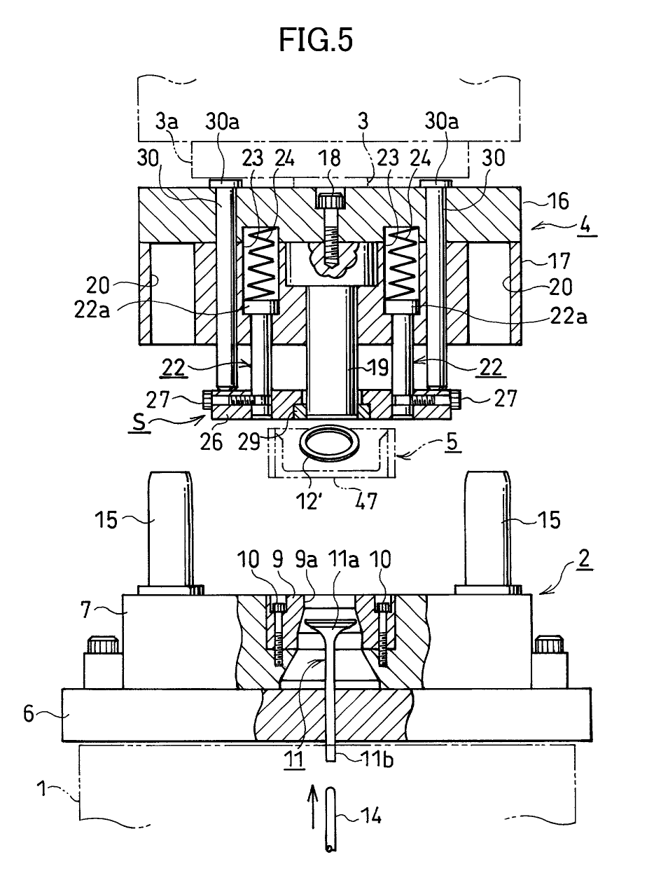

But, as shown in FIG. 5, when the upper die set 4 comes to the upper limit, the upper end of the pressing rod 30 is engaged on the lower surface of the ram plate 3a to press the upper die set 4 down to move the moving plate 26 down, so that the annular burr 12′ is easily removed from the outer circumferential surface of the punch 19.

The annular burr 12′ removed from the punch 19 falls onto the burr receiver 47 by extending the piston rod 33a by the air cylinder 33 of the discharger 5 right before the upper die set 4 comes to the upper limit. Right after it, the piston rod 33a is retracted, and the guide roller 51 which is connected to the rear end of the burr receiver 47 is rotated to the inclined guide bore 45b and stops. As shown in FIG. 8, the annular burr 12′ which falls on the burr receiver 47 is automatically discharged from the rear end by inclining the burr receiver 47 rearwards and by inertial force in which it stops by engagement with the stopper 41.

After the burr receiver 47 moves backward, the workpiece 11 from which the burr is removed is pressed up by elevation of the ejector pin 14, and transferred to the next step while it is held by a workpiece supply/discharge device(not shown).

The present invention is not limited in the foregoing embodiment. In the discharger 5, the burr receiver 47 is inclined downward at the rear limit to discharge the annular burr surely one by one, but the burr receiver 47 may be reciprocally moved front-to-back horizontally by only the horizontal guide bore 45a. By such means, by impact of stopping by contact with the stopper 41, a number of annular burrs 12′ which fall onto the burr receiver 47 is gradually moved backwards by several reciprocal movements and discharged.

The burr receiver 47 may be formed as a box which opens only at the top to hold a number of annular burrs which are periodically discharged after the predetermined number of the burrs are stored.

If it is not necessary to press the upper surface during removal of the burr 12 or if the workpiece 11 is not likely to deviate radially during punching, the compression spring 24 of the stripper device “S” may be omitted. Of course, the present invention may be applied to materials other than the foregoing poppet valve.

The foregoing merely relate to embodiments of the invention. Various change and modifications may be made by persons skilled in the art without departing from the scope of claims wherein:

What is claimed is:

1. A deburring apparatus for a workpiece, comprising:
a lower die which has a hole for supporting a lower surface of a burr formed on an outer circumference of the workpiece;
an elevating plate which is movable up and down opposite to the lower die;
a punch which is fixed to the elevating plate to project downward;
a moving plate which is vertically movable and has a pressing member in which a lower end of the punch is engaged; and
a plurality of pressing rods which are movable up and down with the moving plate and are slidably engaged in the elevating plate, said punch being moved down and engaged in the hole of the lower die to punch the burr of the workpiece, said plurality of pressing rods being engaged on a lower surface of a stationary member when the elevating plate elevates to an upper limit position.

2. An apparatus as claimed in claim 1 wherein the burr of the workpiece is punched to stick at a lower end of the punch when the punch is engaged in the hole of the lower die, the burr which is stuck to the punch being removed from the punch by the pressing member at the lower end of the punch when said plurality of pressing rods are engaged on the lower surface of the stationary member.

3. An apparatus as claimed in claim 1 wherein the moving plate is mounted to a plurality of suspended rods which are energized by a compression spring respectively.

4. An apparatus as claimed in claim 1 wherein a guide plate is provided on a lower surface of the elevating plate, said guide plate having a guide bore which is engaged with a guide rod which is projected on the lower die when the elevating plate is lowered.

5. An apparatus as claimed in claim 1 wherein the pressing member comprises a pressing ring which surrounds on the lower end of the punch.

6. An apparatus as claimed in claim 1 wherein a lower end of the pressing member is slightly projected from the lower end of the punch.

7. An apparatus as claimed in claim 1 wherein the workpiece comprises a poppet valve which is employed in an internal combustion engine of a vehicle.

8. An apparatus as claimed in claim 1 wherein there is provided a discharger for discharging a burr removed from an outer circumferential surface of the punch, said discharger being retracted from a space right under the punch to a rear portion when it receives the burr.

9. An apparatus as claimed in claim 8 wherein said discharger comprises a burr receiver which receives the burr, guide means for guiding the burr receiver horizontally, and means for reciprocating the burr receiver.

10. An apparatus as claimed in claim 9 wherein said guide means comprises a guide plate in which a guide roller horizontally rotates, said guide roller being connected to the burr receiver to guide the burr receiver horizontally, said reciprocating means comprising an air cylinder.

11. An apparatus as claimed in claim 10 wherein the burr receiver opens at a rear end to discharge the burr.

12. An apparatus as claimed in claim 11 wherein the burr receiver is pivoted at a front end and inclined rearward to discharge the burr easily.
